(19) United States
(12) Patent Application Publication
(10) Pub. No.: US 2026/0316383 A1
(43) Pub. Date: Oct. 15, 2026

(54) THREE-DIMENSIONAL SHAPING APPARATUS AND MATERIAL DISCHARGE HEAD

(71) Applicant: SEIKO EPSON CORPORATION, Tokyo (JP)

(72) Inventor: Hui RUAN, MATSUMOTO-SHI (JP)

(21) Appl. No.: 19/645,360

(22) Filed: Apr. 13, 2026

(30) Foreign Application Priority Data
Apr. 15, 2025 (JP) 2025-066882

(51) Int. Cl. B29C 64/209; B29C 64/245; B29C 64/295; B29K 101/12; B29K 503/06

(52) U.S. Cl. CPC B29C 64/209; B29C 64/245; B29C 64/295; B29K 2101/12; B29K 2503/06

(57) ABSTRACT

A three-dimensional shaping apparatus includes a material supply unit, a discharge unit and a stage having a shaping surface on which a material discharged from the discharge unit is deposited. The discharge unit includes a supply port that communicates with the material supply unit, and a flow path forming portion in which a plurality of flow paths, including a first flow path and a second flow path that communicate with the supply port, are formed. A nozzle portion communicates with the plurality of flow paths and discharges the material. The first and second flow paths are arranged side by side along a first direction parallel to the shaping surface. The nozzle portion includes a nozzle flow path that communicates with the first and second flow paths and a nozzle hole, having a longitudinal direction along the first direction, that communicates with the nozzle flow path and discharging the material.

### CROSS REFERENCE TO THE RELATED APPLICATION

The present application is based on, and claims priority from JP Application Serial Number 2025-066882, filed Apr. 15, 2025, the disclosure of which is hereby incorporated by reference herein in its entirety.

### BACKGROUND

### 1. Technical Field

The present disclosure relates to a three-dimensional shaping apparatus and a material discharge head.

### 2. Related Art

JP-A-2023-161368 discloses a three-dimensional shaping apparatus including a tip portion in which a plurality of nozzle holes are formed as a discharge unit that discharges a shaping material.

JP-A-2023-161368 is an example of the related art.

When the plurality of nozzle holes are formed side by side, there is a possibility that a gap is generated between the materials discharged from the nozzle holes. Accordingly, the shaping accuracy may be reduced.

### SUMMARY

According to a first aspect of the present disclosure, a three-dimensional shaping apparatus is provided. The three-dimensional shaping apparatus includes a material supply unit that supplies a material, a discharge unit that communicates with the material supply unit and discharges the material, and a stage having a shaping surface on which the material discharged from the discharge unit is deposited, the discharge unit including a supply port that communicates with the material supply unit and into which the material is supplied, a flow path forming portion in which a plurality of flow paths, including a first flow path and a second flow path that communicate with the supply port, are formed, and a nozzle portion that communicates with the plurality of flow paths and discharges the material, the first flow path and the second flow path being arranged side by side along the first direction parallel to the shaping surface, and the nozzle portion including a nozzle flow path that communicates with the first and second flow paths and a nozzle hole having a longitudinal direction along the first direction, communicating with the nozzle flow path and discharging the material.

According to a second aspect of the present disclosure, a material discharge head that discharges a material onto a stage is provided. The material discharge head includes a discharge unit that discharges the material, the discharge unit including a supply port into which the material is supplied, a flow path forming portion in which a plurality of flow paths, including a first flow path and a second flow path that communicate with the supply port, are formed, and a nozzle portion that communicates with the plurality of flow paths and discharges the material, the first flow path and the second flow path being arranged side by side along the first direction parallel to the surface of the stage, and the nozzle portion including a nozzle flow path that communicates with the first and second flow paths and a nozzle hole having a longitudinal direction along the first direction, communicating with the nozzle flow path and discharging the material.

### BRIEF DESCRIPTION OF THE DRAWINGS

FIG. 1 is a diagram showing a schematic configuration of a three-dimensional shaping apparatus.

FIG. 2 is a perspective view showing a schematic configuration of a screw.

FIG. 3 is a perspective view of a discharge unit.

FIG. 4 is a side view of a discharge unit.

FIG. 5 is a cross-sectional view along line V-V shown in FIG. 4.

FIG. 6 is a cross-sectional view along line VI-VI shown in FIG. 5.

FIG. 7 is an enlarged view of the vicinity of the nozzle flow path shown in FIG. 6.

FIG. 8 is a diagram illustrating the lengths of the respective parts of the discharge unit.

FIG. 9 is a cross-sectional view along line V–V in shown FIG. 4 according to the second embodiment.

### DESCRIPTION OF EMBODIMENTS

### First Embodiment:

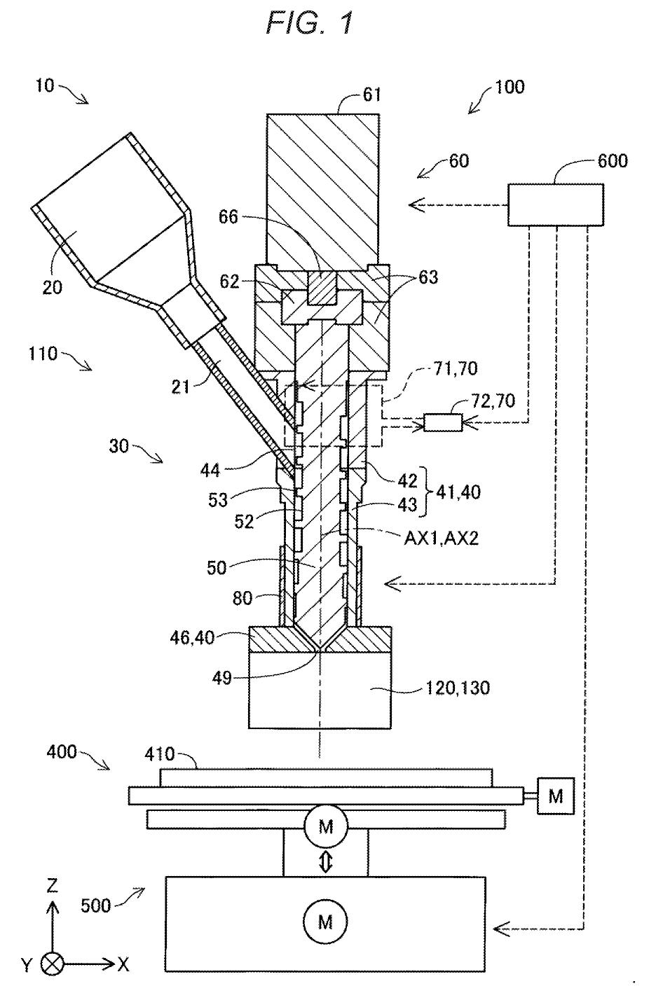

FIG. 1 is a diagram showing a schematic configuration of a three-dimensional shaping apparatus 10. FIG. 1 shows arrows indicating X, Y, and Z directions orthogonal to one another. The X directions and the Y directions are parallel to a horizontal plane. The Z direction is parallel to a vertical direction. The X, Y, and Z directions in FIG. 1 and the X, Y, and Z directions in the other drawings indicate the same directions. When a direction is specified, positive or negative signs are used together for direction notation with a positive direction, which is a direction indicated by an arrow, represented as "+" and a negative direction, which is a direction opposite to the direction indicated by the arrow, represented as "-". The +Z direction is also referred to as "upward" and the -Z direction is also referred to as "downward".

The three-dimensional shaping apparatus 10 includes a material discharge head 100, a stage 400, a moving mechanism 500, and a control unit 600. Under the control of the control unit 600, the three-dimensional shaping apparatus 10 shapes a three-dimensional shaped object in which a layer of a shaping material is stacked on a shaping surface 410 by driving the moving mechanism 500 to change the relative position between a discharge unit 120 and the shaping surface 410, while discharging the shaping material, which is a plasticized material, from the discharge unit 120 of the material discharge head 100 described later toward the shaping surface 410 of the stage 400.

The stage 400 is supported by the moving mechanism 500. The stage 400 has the shaping surface 410 facing the discharge unit 120 of the material discharge head 100. The shaping surface 410 is provided parallel to the horizontal plane. The shaping material discharged from the discharge unit 120 is deposited on the shaping surface 410.

The moving mechanism 500 changes the relative position between the discharge unit 120 of the material discharge head 100 and the shaping surface 410. In the present embodiment, the moving mechanism 500 supports the stage 400, and changes the relative position between the discharge unit 120 and the shaping surface 410 by moving the stage 400 with respect to the material discharge head 100. The moving mechanism 500 in the present embodiment includes a three-axis positioner that moves the stage 400 in three axial directions of the X, Y, and Z directions with driving forces of three motors. Each motor is driven under control of the control unit 600. The moving mechanism 500 may be configured to change the relative position between the discharge unit 120 and the shaping surface 410 by moving the material discharge head 100 without moving the stage 400, instead of moving the stage 400. The moving mechanism 500 may be configured to change the relative position between the discharge unit 120 and the shaping surface 410 by moving both the stage 400 and the material discharge head 100.

The control unit 600 includes a computer including one or more processors, a storage device, and an input and output interface for inputting and outputting signals from and to the outside. The control unit 600 exerts various functions such as a function of executing shaping processing for shaping the three-dimensional shaped object by the processor executing a program or a command read into a main storage device. The control unit 600 may be implemented by a configuration in which a plurality of circuits for implementing at least a part of the function are combined, instead of being implemented with the computer.

The material discharge head 100 discharges the shaping material obtained by plasticizing the material in a solid state onto the shaping surface 410 of the stage 400 under the control of the control unit 600. "Plasticize" is a concept including melting and means changing a solid to a state having fluidity. Specifically, in the case of a material in which glass transition occurs, "plasticize" means setting the temperature of the material to temperature equal to or higher than the glass transition point. In the case of a material in which glass transition does not occur, "plasticizing" refers to setting a temperature of the material to a temperature equal to or higher than a melting point. The material discharge head 100 includes a material supply unit 110, the discharge unit 120, and a heating unit 130.

The material supply unit 110 includes a hopper 20 and a plasticizing unit 30. The hopper 20 houses a material in the form of pellets containing a metal powder and a binder. The metal powder is made of a single metal such as magnesium (Mg), iron (Fe), cobalt (Co), chromium (Cr), aluminum (Al), titanium (Ti), copper (Cu), or nickel (Ni), powder containing two or more of the metals described above, or an alloy containing two or more of the metals described above. Examples of the alloy described above include a Maraging steel, a cobalt-chromium-molybdenum alloy, a titanium alloy, a nickel alloy, an aluminum alloy, a cobalt alloy, and a cobalt-chromium alloy. The binder contains resin and wax. The resin is acrylic resin, epoxy resin, silicone resin, cellulose-based resin, or any other synthetic resin, or thermoplastic resin such as polylactic acid (PLA), polyamide (PA), polyphenylene sulfide (PPS), or polyetheretherketone (PEEK). The material housed in the hopper 20 may not contain the metal powder and the binder and may be a thermoplastic resin. A communication path 21, which couples the hopper 20 and the plasticizing unit 30, is provided below the hopper 20. The communication path 21 is coupled to a cylinder 40 described later from the obliquely upward direction. The communication path 21 has a cylindrical shape. The hopper 20 supplies the material to the plasticizing unit 30 via the communication path 21.

The plasticizing unit 30 plasticizes at least a part of the material supplied from the hopper 20, generates a paste-like shaping material having flowability, and guides the shaped material to the discharge unit 120. The plasticizing unit 30 includes the cylinder 40, a screw 50, a screw drive section 60, a cooling section 70, and a cylinder heating section 80. The screw drive section 60, the cylinder 40, and the discharge unit 120 are disposed in this order from the upper side to the lower side.

The cylinder 40 includes a main body section 41 and a nozzle fixing section 46 provided at the lower end of the main body section 41. The main body section 41 has a cylindrical shape centering on a central axis AX1. The main body section 41 is disposed such that the central axis AX1 extends in the vertical direction. The main body section 41 includes a first portion 42 and a second portion 43 located below the first portion 42. A material supply port 44 to which a material is supplied from the material supply unit 110 via the communication path 21 is provided at a connecting section between the first portion 42 and the second portion 43. The material supply port 44 may be provided in the first portion 42. An upper end of the first portion 42 is formed in a flange shape. The screw drive section 60 is fixed to the upper end of the first portion 42. A nozzle fixing section 46 is fixed to a lower end of the second portion 43. A through hole 49 penetrating the nozzle fixing section 46 in the Z direction is provided at the center of the nozzle fixing section 46. The discharge unit 120 is coupled to the lower end of the nozzle fixing section 46.

In the present embodiment, the first portion 42, the second portion 43, and the nozzle fixing section 46 are respectively formed of stainless steel. In the present embodiment, the first portion 42 and the second portion 43 are integrally formed. For example, the first portion 42 and the second portion 43 can be integrally formed by bonding the first portion 42 and the second portion 43 using a metal bonding technique such as diffusion bonding or hot isostatic press (HIP) bonding. The first portion 42 and the second portion 43 may be integrally formed using a three-dimensional shaping technique. At least one of the first portion 42 and the second portion 43 may be formed of, rather than stainless steel, for example, another metal material such as a titanium alloy, a resin material, or a ceramic material. The first portion 42 and the second portion 43 may be formed of different metal materials.

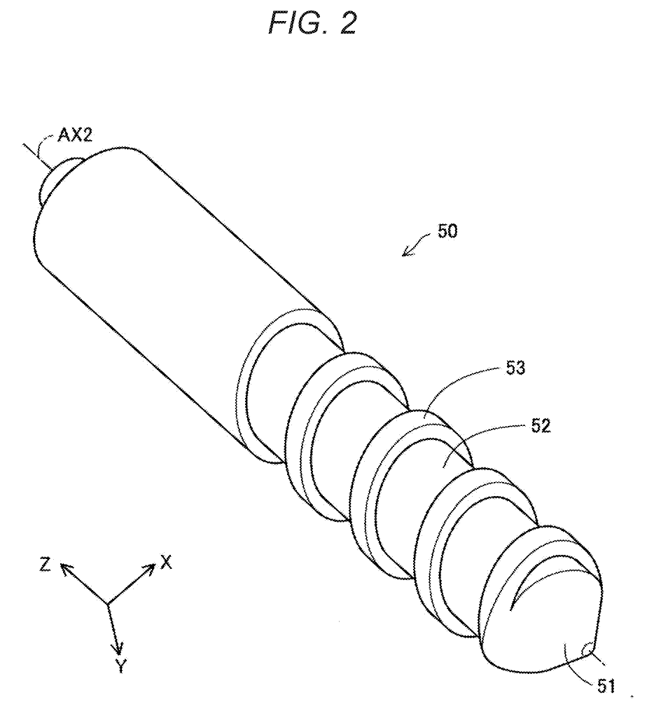

FIG. 2 is a perspective view showing a schematic configuration of the screw 50. Hereinafter, a configuration of the screw 50 is explained with reference to FIGS. 1 and 2. The screw 50 is housed inside the cylinder 40. More specifically, the screw 50 is housed in a space surrounded by the main body section 41 of the cylinder 40, the nozzle fixing section 46 of the cylinder 40, and a gear case 63 of the screw drive section 60 described later. The screw 50 has an axial shape centering on a rotation axis AX2. The screw 50 is disposed such that the rotation axis AX2 extends along the central axis AX1 of the main body section 41 of the cylinder 40. An upper end of the screw 50 is coupled to the screw drive section 60. A distal end portion 51 of the screw 50 is located in the vicinity of the through hole 49. A spiral groove section 52 centering on the rotation axis AX2 is provided in a side surface portion of the screw 50. The groove section 52 is provided continuously from a portion of the screw 50 located above the material supply port 44 to the distal end portion 51 of the screw 50. A spiral flight section 53 that separates pieces of the groove section 52 from one another is provided between the pieces of the groove section 52. In addition, a plurality of groove sections 52 may be provided in the side surface portion of the screw 50. For example, two groove sections 52 may be provided in a double spiral shape in the side surface portion of the screw 50. In the present embodiment, the screw 50 is formed of stainless steel subjected to quenching. The screw 50 may be formed of, rather than the stainless steel subjected to the quenching, for example, another metal material such as a titanium alloy or may be formed of a resin material or a ceramic material.

The screw drive section 60 shown in FIG. 1 includes a drive motor 61, a speed reducer 62, and the gear case 63. The gear case 63 is fixed to an upper end of the first portion 42 of the cylinder 40. The speed reducer 62 is housed inside the gear case 63. The drive motor 61 is fixed to the upper surface of the gear case 63. In the present embodiment, a servo motor is used as the drive motor 61. In the present embodiment, the speed reducer 62 includes a gear. The drive motor 61 is driven under the control of the control unit 600. A rotating shaft 66 of the drive motor 61 is coupled to the upper end portion of the screw 50 via the speed reducer 62. The screw 50 rotates centering on the rotation axis AX2 inside the cylinder 40 with torque applied from the drive motor 61 via the speed reducer 62. As the drive motor 61, for example, a stepping motor may be used. The speed reducer 62 may include a pulley and a belt. The screw drive section 60 may not include the speed reducer 62 and the gear case 63. The rotating shaft 66 of the drive motor 61 may be coupled to the upper end portion of the screw 50.

The cooling unit 70 includes a coolant flow path 71 through which a coolant flows, and a coolant supply section 72. The coolant flow path 71 is provided in the cylinder 40. The coolant flow path 71 is provided inside the first portion 42 as a three-dimensional path passing through the vicinity of the material supply port 44. The coolant flow path 71 includes a hole including a three-dimensional path provided in the first portion 42. Both ends of the coolant flow path 71 are coupled to the coolant supply section 72 via a pipe or the like. The coolant supply section 72 includes a chiller that removes heat from the coolant that has flowed through the coolant flow path 71 while circulating the coolant through the coolant flow path 71. The coolant supply section 72 is driven under the control of the control unit 600. In the present embodiment, water is used as the coolant. As the coolant, for example, oil or air may be used rather than water. Instead of both ends of the coolant flow path 71, only one end of the coolant flow path 71 may be coupled to the coolant supply section 72. In this case, for example, the coolant may be discharged to the outside from the other end of the coolant flow path 71.

The cylinder heating section 80 heats the material supplied into the cylinder 40. The cylinder heating section 80 is an electric heater. The cylinder heating section 80 is provided along a portion located between the material supply port 44 and the discharge unit 120 on the surface of the outer circumference of the second portion 43. The cylinder heating section 80 may be embedded in the outer circumference of the second portion 43 located between the material supply port 44 and the discharge unit 120. The temperature of the cylinder heating section 80 is controlled by the control unit 600. For example, the control unit 600 may control the temperature of the cylinder heating section 80 using temperature acquired by a temperature sensor provided in the cylinder heating section 80. The cylinder heating section 80 is not limited to the electric heater and may be a gas heating type heater or the like.

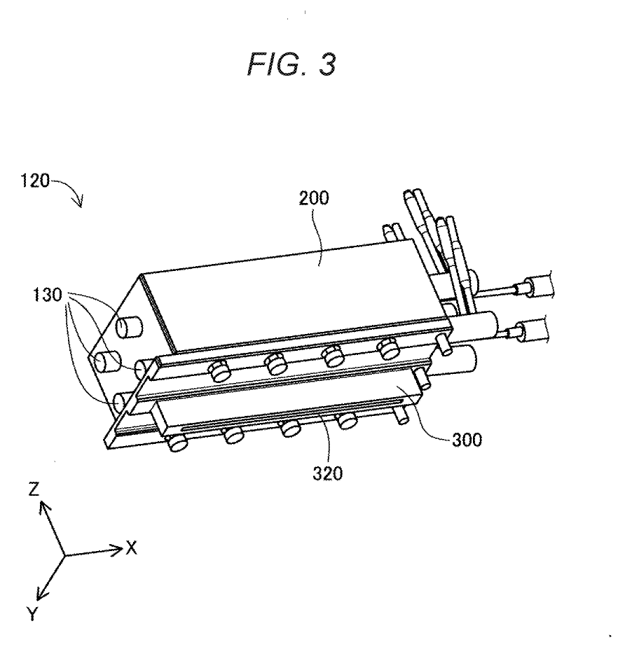

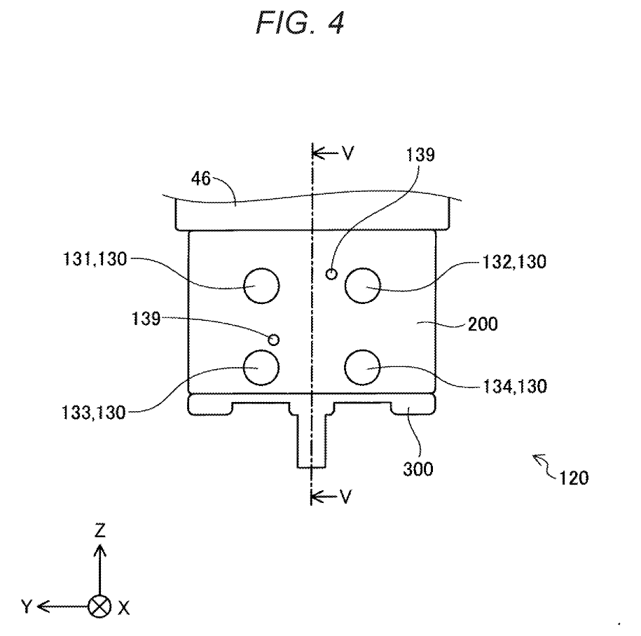

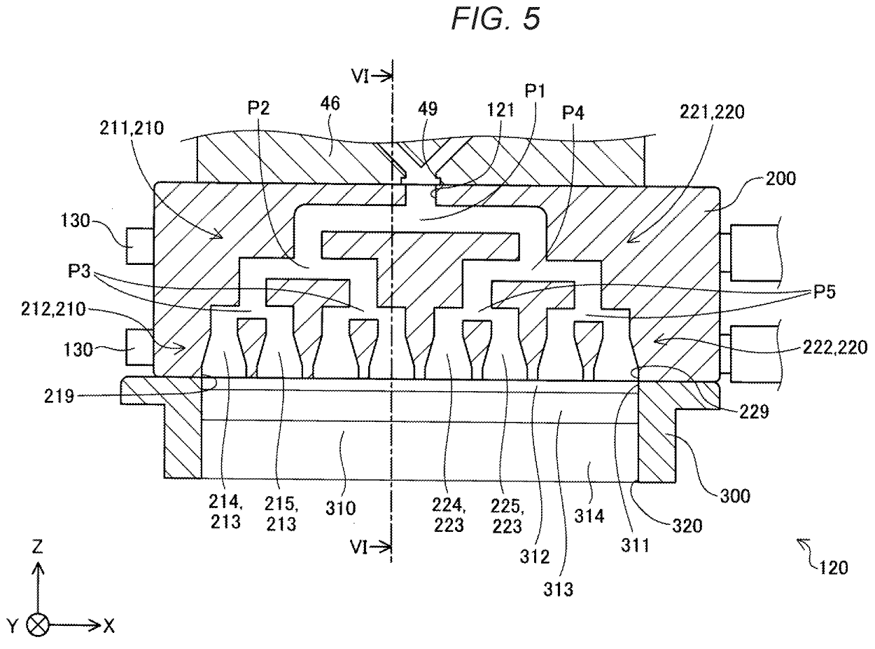

FIG. 3 is a perspective view of the discharge unit 120. FIG. 4 is a side view of the discharge unit 120. FIG. 5 is a cross-sectional view along line V-V shown in FIG. 4. The discharge unit 120 communicates with the material supply unit 110 and discharges the shaping material that is generated in the material supply unit 110 toward the shaping surface 410 of the stage 400. The discharge unit 120 is coupled to the lower surface of the nozzle fixing section 46. The discharge unit 120 includes a supply port 121, a flow path forming portion 200, and a nozzle portion 300.

As shown in FIG. 5, the supply port 121 communicates with the through hole 49 of the nozzle fixing section 46. That is, the supply port 121 communicates with the material supply unit 110. The shaping material is supplied from the material supply unit 110 to the supply port 121.

A plurality of flow paths communicating with the supply port 121 are formed in the flow path forming portion 200. The flow path forming portion 200 is formed of stainless steel. The flow path forming portion 200 may be formed of, rather than the stainless steel, for example, another metal material such as a titanium alloy or may be formed of a resin material or a ceramic material. The flow path formed in the flow path forming portion 200 extends from the supply port 121 to a first branch point P1 and then branches into two flow paths extending in the +X direction and the -X direction at the first branch point P1. Hereinafter, a flow path extending from the first branch point P1 to the -X direction side is referred to as a first flow path 210, and a flow path extending from the first branch point P1 to the +X direction side is referred to as a second flow path 220. That is, the first flow path 210 and the second flow path 220 communicating with the supply port 121 are formed in the flow path forming portion 200. The first flow path 210 and the second flow path 220 are arranged side by side along the first direction parallel to the shaping surface 410. In the present embodiment, the first direction is the X direction. The first direction includes the first positive direction and the first reverse direction opposite to the first positive direction. In the present embodiment, the first positive direction is the +X direction, and the first reverse direction is the -X direction. The second flow path 220 is located on the first positive direction side of the first flow path 210.

The first flow path 210 extends from the first branch point P1 to a second branch point P2, and then branches into two flow paths extending in the +X direction and the -X direction at the second branch point P2. Each flow path branched at the second branch point P2 extends to a third branch point P3, and then branches into two flow paths extending in the +X direction and the -X direction at the third branch point P3. Each flow path branched at the third branch point P3 communicates with a nozzle flow path 310 of the nozzle portion 300 described later at a first connection port 219 which is a lower end portion of the first flow path 210. In other words, the first flow path 210 has the first connection port 219 which is an end portion communicating with the nozzle flow path 310. In the present embodiment, the first flow path 210 has four first connection ports 219. In the present embodiment, in the first flow path 210, a portion from the first branch point P1 to the third branch point P3 is referred to as a first upstream path 211, and a portion from the third branch point P3 to the first connection port 219 is referred to as a first downstream path 212. That is, the first flow path 210 includes the first upstream path 211 communicating with the supply port 121 and the first downstream path 212 communicating with the first upstream path 211 and the nozzle flow path 310.

The first downstream path 212 includes a plurality of the downstream branch paths 213 communicating with the first upstream path 211 and the nozzle flow path 310. The downstream branch path 213 is a portion of the first downstream path 212 from the third branch point P3 to each first connection port 219. In the present embodiment, the first downstream path 212 includes four downstream branch paths 213. In the present embodiment, the first downstream path 212 has four downstream branch paths 213, among which the downstream branch path 213 located closest to the −X direction side is referred to as a first downstream branch path 214, and the downstream branch path 213 located second closest to the −X direction side is referred to as a second downstream branch path 215. That is, the first downstream path 212 includes the first downstream branch path 214 and the second downstream branch path 215.

The second flow path 220 extends from the first branch point P1 to a fourth branch point P4 and then branches into two flow paths extending in the +X direction and the -X direction at the fourth branch point P4. Each flow path branched at the fourth branch point P4 extends to the fifth branch point P5 and then branches into two flow paths extending in the +X direction and the -X direction at the fifth branch point P5. Each flow path branched at the fifth branch point P5 communicates with the nozzle flow path 310 at a second connection port 229 which is a lower end portion of the second flow path 220. In other words, the second flow path 220 has the second connection port 229 which is an end portion communicating with the nozzle flow path 310. In the present embodiment, the second flow path 220 has four second connection ports 229. In the present embodiment, in the second flow path 220, a portion from the first branch point P1 to the fifth branch point P5 is referred to as a second upstream path 221, and a portion from the fifth branch point P5 to the second connection port 229 is referred to as a second downstream path 222. That is, the second flow path 220 includes the second upstream path 221 communicating with the supply port 121 and a second downstream path 222 communicating with the second upstream path 221 and the nozzle flow path 310.

The second downstream path 222 includes a plurality of the downstream branch paths 223 communicating with the second upstream path 221 and the nozzle flow path 310. The downstream branch path 223 is a portion of the second downstream path 222 from the fifth branch point P5 to each second connection port 229. In the present embodiment, the second downstream path 222 includes four downstream branch paths 223. In the present embodiment, the second downstream path 222 has four downstream branch paths 223, among which the downstream branch path 223 located closest to the −X direction side is referred to as a third downstream branch path 224, and the downstream branch path 223 located second closest to the −X direction side is referred to as a fourth downstream branch path 225. That is, the second downstream path 222 includes the third downstream branch path 224 and the fourth downstream branch path 225.

The downstream branch paths 213 of the first downstream path 212 and the downstream branch paths 223 of the second downstream path 222 are arranged along the first direction. That is, the first downstream branch path 214, the second downstream branch path 215, the third downstream branch path 224, and the fourth downstream branch path 225 are arranged side by side along the first direction. Further, each first connection port 219 and each second connection port 229 are arranged side by side along the first direction. The second connection port 229 is located on the first positive direction side of the first connection port 219. The first connection ports 219 and the second connection ports 229 are arranged at regular intervals along the first direction. The size of each first connection port 219 and the size of each second connection port 229 are the same. When viewed in the +Z direction, each first connection port 219 and each second connection port 229 has a rectangular shape having a longitudinal direction along the first direction. When viewed in the +Z direction, each first connection port 219 and each second connection port 229 may have a circular shape, an elliptical shape, a polygonal shape, or the like.

The nozzle portion 300 is provided below the flow path forming portion 200. The nozzle portion 300 is formed of stainless steel. The nozzle portion 300 may be formed of, rather than the stainless steel, for example, another metal material such as a titanium alloy or may be formed of a resin material or a ceramic material. The nozzle portion 300 has the nozzle flow path 310 and a nozzle hole 320.

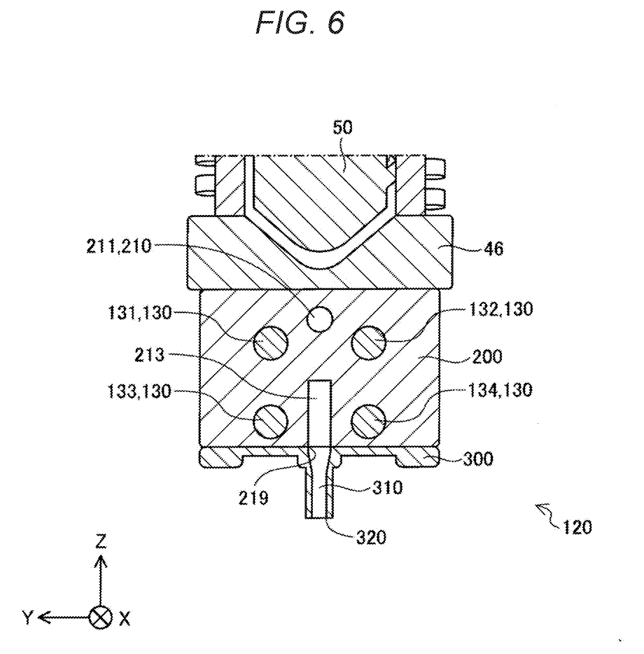

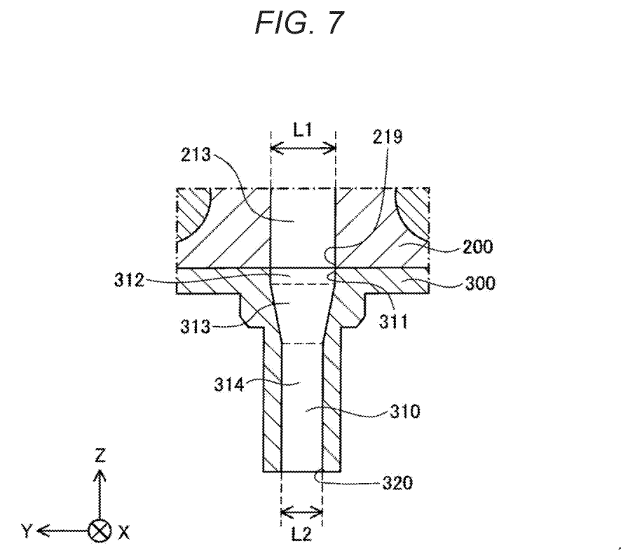

FIG. 6 is a cross-sectional view along line VI-VI shown in FIG. 5. FIG. 7 is an enlarged view of the vicinity of the nozzle flow path 310 shown in FIG. 6. Hereinafter, the configuration of the nozzle portion 300 will be described with reference to FIGS. 5 - 7.

The nozzle flow path 310 communicates with the first flow path 210 and the second flow path 220. Specifically, the nozzle flow path 310 communicates with the first flow path 210 by communicating with the four first connection ports 219 and communicates with the second flow path 220 by communicating with the four second connection ports 229. The nozzle flow path 310 includes a first constant width portion 312, a narrowed portion 313, and a second constant width portion 314. The first constant width portion 312, the narrowed portion 313, and the second constant width portion 314 are provided in this order from top to bottom. The first constant width portion 312, the narrowed portion 313, and the second constant width portion 314 are provided along the first direction from the end portion of the nozzle flow path 310 on the -X direction side to the end portion on the +X direction side. The first constant width portion 312 and the second constant width portion 314 are portions in which the width of the nozzle flow path 310 in the third direction is constant. Here, the third direction is a direction parallel to the shaping surface 410 and orthogonal to the first direction. In the present embodiment, the third direction is the Y direction. The narrowed portion 313 is a portion in which the width of the nozzle flow path 310 in the third direction decreases from the upper side toward the lower side. In the present embodiment, the narrowed portion 313 has a tapered shape in which the width of the nozzle flow path 310 in the third direction decreases from the upper side toward the lower side. The width of the nozzle flow path 310 in the first direction is constant regardless of the position in the vertical direction. Therefore, in the first constant width portion 312 and the second constant width portion 314, the cross-sectional area of the nozzle flow path 310 cut along a plane parallel to the horizontal plane is constant regardless of the position in the vertical direction. In the narrowed portion 313, the cross-sectional area of the nozzle flow path 310 cut along a plane parallel to the horizontal plane decreases from the upper side toward the lower side.

The nozzle hole 320 is an opening located at the lower end of the nozzle portion 300. The nozzle hole 320 communicates with the nozzle flow path 310 and discharges the shaping material generated by the material supply unit 110 toward the shaping surface 410 of the stage 400. The nozzle hole 320 is an opening having a longitudinal direction along the first direction. In the present embodiment, when viewed in the +Z direction, the nozzle hole 320 has a rectangular shape whose longitudinal direction extends along the first direction. As described above, since the width of the nozzle flow path 310 in the first direction is constant regardless of the position in the vertical direction, the width of the upper end portion 311 of the nozzle flow path 310 in the first direction is equal to the width of the nozzle hole 320 in the first direction.

As shown in FIG. 7, the width of the first connection port 219 in the third direction is equal to the width of the upper end portion 311 of the nozzle flow path 310. Since the width of the first connection port 219 in the third direction is equal to the width of the second connection port 229 in the third direction, the width of the second connection port 229 in the third direction is equal to the width of the upper end portion 311 of the nozzle flow path 310. The width L2 of the nozzle hole 320 in the third direction is smaller than the width L1 of the upper end portion 311 of the nozzle flow path 310 in the third direction. That is, the width of the nozzle hole 320 in the third direction is smaller than the width of the first connection port 219 in the third direction and the width of the second connection port 229 in the third direction.

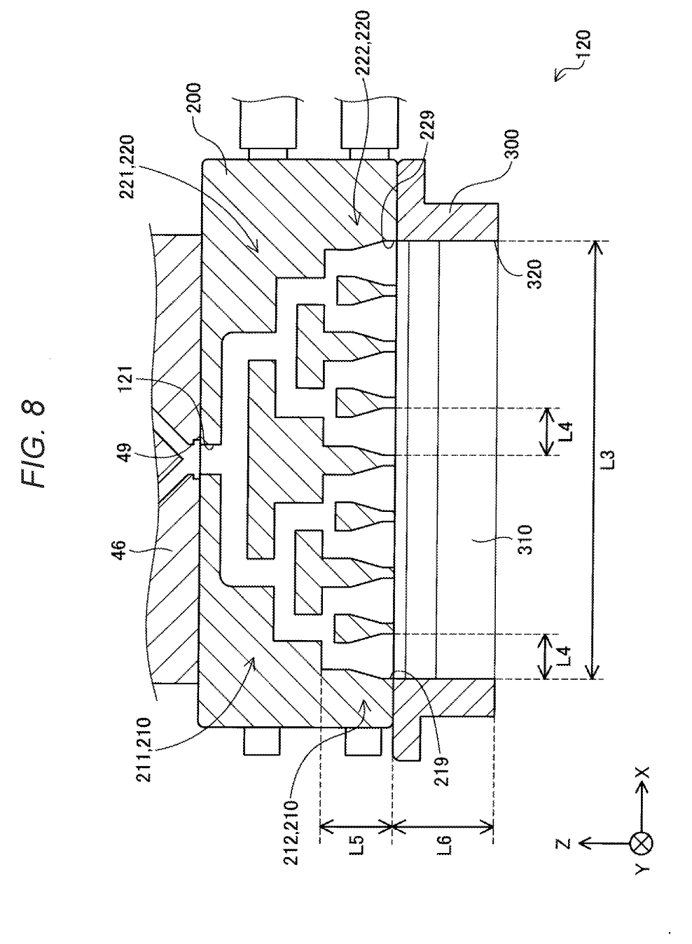

FIG. 8 is a diagram illustrating the lengths of the respective parts of the discharge unit 120. As shown in FIG. 8, the width L3 of the nozzle hole 320 in the first direction is larger than the sum of the width of the first connection port 219 in the first direction and the width of the second connection port 229 in the first direction. Here, the sum of the width of the first connection port 219 in the first direction and the width of the second connection port 229 in the first direction is the sum of the widths of all the first connection ports 219 and the widths of all the second connection ports 229. In the present embodiment, since the width of each first connection port 219 in the first direction is equal to the width of each second connection port 229 in the first direction, the sum of the widths of the first and second connection ports 219 and 229 in the first direction is 8 × L4.

The length of the first downstream path 212 in the second direction is equal to the length of the second downstream path 222 in the second direction. Here, the second direction is a direction perpendicular to the shaping surface 410. In the present embodiment, the second direction is the Z direction. The length L6 of the nozzle flow path 310 in the second direction is longer than the length L5 of the first downstream path 212 in the second direction and the length L5 of the second downstream path 222 in the second direction.

The heating unit 130 shown in FIGS. 3 - 6 heats the shaping material inside the discharge unit 120 by heating the discharge unit 120. The heating unit 130 is, for example, a rod-shaped heater. The heating unit 130 penetrates the flow path forming portion 200 in the X direction. That is, the heating unit 130 extends in the first direction. The heating unit 130 is located above the nozzle portion 300. Therefore, the distance between the heating unit 130 and the flow path forming portion 200 in the second direction is shorter than the distance between the heating unit 130 and the nozzle portion 300 in the second direction. The temperature of the heating unit 130 is controlled by the control unit 600.

As shown in FIGS. 4 and 6, the heating unit 130 includes a first heating unit 131, a second heating unit 132, a third heating unit 133, and a fourth heating unit 134. The first heating unit 131 and the second heating unit 132 are arranged in the Y direction. The third heating unit 133 and the fourth heating unit 134 are arranged in the Y direction below the first heating unit 131 and the second heating unit 132. The first heating unit 131 and the third heating unit 133 are arranged in the Z direction. The second heating unit 132 and the fourth heating unit 134 are arranged in the Z direction. The first flow path 210 and the second flow path 220 are located between the first heating unit 131 and the second heating unit 132 and between the third heating unit 133 and the fourth heating unit 134 in the Y direction.

The heating unit 130 controls the temperature of the heating unit 130 based on the detection value of the temperature sensor 139 provided in the flow path forming portion 200. The temperature sensor 139 is, for example, a thermocouple. As shown in FIG. 4, the temperature sensor 139 is provided in the vicinity of the second heating unit 132 and the third heating unit 133. The number and positions of the temperature sensors 139 are not limited to the example described above.

According to the first embodiment described above, a plurality of flow paths including the first flow path 210 and the second flow path 220 communicating with the supply port 121 are formed in the flow path forming portion 200. The first flow path 210 and the second flow path 220 are arranged side by side along the first direction parallel to the shaping surface 410. The nozzle portion 300 includes the nozzle flow path 310 communicating with the first flow path 210 and the second flow path 220, and the nozzle hole 320 having a longitudinal direction along the first direction and communicating with the nozzle flow path 310 to discharge a material. The shaping material supplied to the supply port 121 branches into the first flow path 210 and the second flow path 220 in the flow path forming portion 200, and merges in the nozzle flow path 310 of the nozzle portion 300. Therefore, the shaping material passing through the first flow path 210 and the shaping material passing through the second flow path 220 come into close contact with each other in the nozzle flow path 310, thereby making it easier to fill a gap in the first direction between the shaping material passing through the first flow path 210 and the shaping material passing through the second flow path 220. Therefore, the possibility that a gap is generated in the shaping material discharged from the nozzle hole 320 can be reduced, thereby improving the shaping accuracy. Since the first flow path 210 and the second flow path 220 are arranged side by side along the first direction, the shaping material supplied to the supply port 121 branches into the first flow path 210 and the second flow path 220, thereby suppressing variations in the flow rate of the shaping material passing through the nozzle flow path 310 depending on the position in the first direction.

In the present embodiment, the width of the nozzle hole 320 in the first direction is larger than the sum of the width of the first connection port 219 in the first direction and the width of the second connection port 229 in the first direction. Therefore, it is possible to improve the shaping speed while improving the shaping accuracy.

In the present embodiment, the first flow path 210 includes the first upstream path 211 communicating with the supply port 121 and the first downstream path 212 communicating with the first upstream path 211 and the nozzle flow path 310. The first downstream path 212 includes the first downstream branch path 214 and the second downstream branch path 215 that communicate with the first upstream path 211 and the nozzle flow path 310. The second flow path 220 includes a second upstream path 221 communicating with the supply port 121, and the second downstream path 222 communicating with the second upstream path 221 and the nozzle flow path 310. The second downstream path 222 includes the third downstream branch path 224 and the fourth downstream branch path 225 that communicate with the second upstream path 221 and the nozzle flow path 310. The first downstream branch path 214, the second downstream branch path 215, the third downstream branch path 224, and the fourth downstream branch path 225 are arranged side by side along the first direction. Therefore, the shaping material supplied to the supply port 121 branches into the first downstream branch path 214, the second downstream branch path 215, the third downstream branch path 224, and the fourth downstream branch path 225. Therefore, variation in the flow rate of the shaping material passing through the nozzle flow path 310 depending on the position in the first direction can be further suppressed.

In the present embodiment, the length L6 of the nozzle flow path 310 in the second direction perpendicular to the shaping surface 410 is longer than the length L5 of the first downstream path 212 in the second direction and the length L5 of the second downstream path 222 in the second direction. Therefore, the shaping material passing through the first flow path 210 and the shaping material passing through the second flow path 220 can come into closer contact with each other in the nozzle flow path 310. Accordingly, the possibility that a gap is generated in the shaping material discharged from the nozzle hole 320 can be further reduced.

In the present embodiment, the width L2 of the nozzle hole 320 in the third direction parallel to the shaping surface 410 and orthogonal to the first direction is smaller than the width L1 of the first connection port 219 in the third direction and the width L1 of the second connection port 229 in the third direction. Therefore, the shaping material passing through the first flow path 210 and the shaping material passing through the second flow path 220 can come into closer contact with each other in the nozzle flow path 310. Accordingly, the possibility that a gap is generated in the shaping material discharged from the nozzle hole 320 can be further reduced.

In the present embodiment, the width L2 of the nozzle hole 320 in the third direction is smaller than the width L1 of the upper end portion 311 of the nozzle flow path 310 in the third direction. Therefore, the shaping material passing through the first flow path 210 and the shaping material passing through the second flow path 220 can come into closer contact with each other in the nozzle flow path 310. Accordingly, the possibility that a gap is generated in the shaping material discharged from the nozzle hole 320 can be further reduced.

In the present embodiment, the nozzle flow path 310 has the narrowed portion 313 in which the width of the nozzle flow path 310 in the third direction decreases from the upper side toward the lower side. Therefore, the shaping material passing through the first flow path 210 and the shaping material passing through the second flow path 220 can come into closer contact with each other in the narrowed portion 313. Accordingly, the possibility that a gap is generated in the shaping material discharged from the nozzle hole 320 can be further reduced.

In the present embodiment, the material discharge head 100 includes the heating unit 130 that heats the discharge unit 120, and the distance between the heating unit 130 and the flow path forming portion 200 in the second direction perpendicular to the shaping surface 410 is shorter than the distance between the heating unit 130 and the nozzle portion 300 in the second direction. Therefore, the shaping material inside the nozzle portion 300 is readily cooled, making it easier to discharge the shaping material from the nozzle hole 320 at a temperature suitable for shaping.

### Second Embodiment

The second embodiment is different from the first embodiment in the shape of a nozzle portion 300b. The configuration of each portion of a three-dimensional shaping apparatus 10 other than the nozzle portion 300b is the same as that of the first embodiment.

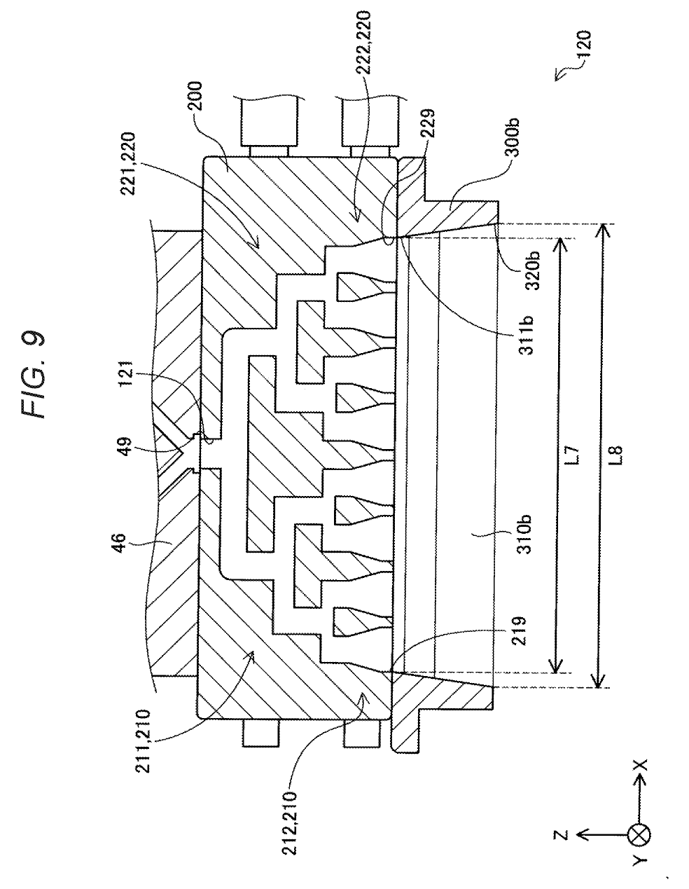

FIG. 9 is a cross-sectional view along line V–V in shown FIG. 4 according to the second embodiment. In the second embodiment, the width L8 of a nozzle hole 320b in the first direction is larger than the distance L7 in the first direction from the end portion of a first connection port 219 on the first reverse direction side to the end portion of a second connection port 229 on the first positive direction side. In the second embodiment, the distance in the first direction from the end portion of the first connection port 219 on the first reverse direction side to the end portion of the second connection port 229 on the first positive direction side is equal to the width in the first direction of the upper end portion 311b of the nozzle flow path 310b. That is, the width of the nozzle hole 320b in the first direction is larger than the width of the upper end portion 311b of the nozzle flow path 310b in the first direction. The width of the nozzle flow path 310b in the first direction increases from the upper side toward the lower side. When viewed in the +Z direction, the nozzle hole 320b has a rectangular shape whose longitudinal direction extends along the first direction.

According to the second embodiment described above, the width L8 of the nozzle hole 320b in the first direction is larger than the distance L7 in the first direction from the end portion of the first connection port 219 on the first reverse direction side to the end portion of the second connection port 229 on the first positive direction side. Therefore, a shaped object having a wider width in the first direction can be formed than in a case where the width of the nozzle hole 320b in the first direction is equal to the distance in the first direction from the end portion of the first connection port 219 on the first reverse direction side to the end portion of the second connection port 229 on the first positive direction side.

### Other Embodiments

(C-1) In the embodiment described above, the first flow path 210 and the second flow path 220 communicating with the supply port 121 are formed in the flow path forming portion 200. In contrast, three or more flow paths communicating with the supply port 121 may be formed in the flow path forming portion 200.

(C-2) In the embodiment described above, the first upstream path 211 branches into two flow paths extending in the +X direction and the -X direction at the second branch point P2. In contrast, the first upstream path 211 may be one flow path that does not branch.

(C-3) In the embodiment described above, the second upstream path 221 branches into two flow paths extending in the +X direction and the -X direction at the fourth branch point P4. In contrast, the second upstream path 221 may be one flow path that does not branch.

(C-4) In the embodiment described above, the first downstream path 212 includes the first downstream branch path 214 and the second downstream branch path 215 that communicate with the first upstream path 211 and the nozzle flow path 310. In contrast, the first downstream path 212 may be one flow path that does not branch.

(C-5) In the embodiment described above, the second downstream path 222 includes the third downstream branch path 224 and the fourth downstream branch path 225 that communicate with the second upstream path 221 and the nozzle flow path 310. In contrast, the second downstream path 222 may be one flow path that does not branch.

(C-6) In the embodiment described above, when viewed in the +Z direction, the nozzle hole 320 has a rectangular shape whose longitudinal direction extends along the first direction. In contrast, when viewed in the +Z direction, the nozzle hole 320 may have an elliptical shape, a polygonal shape, or the like whose longitudinal direction extends along the first direction.

(C-7) In the embodiment described above, the width of the nozzle hole 320 in the first direction is larger than the sum of the width of the first connection port 219 in the first direction and the width of the second connection port 229 in the first direction. In contrast, the width of the nozzle hole 320 in the first direction may be equal to or less than the sum of the width of the first connection port 219 in the first direction and the width of the second connection port 229 in the first direction.

(C-8) In the embodiment described above, the length L6 of the nozzle flow path 310 in the second direction is longer than the length L5 of the first downstream path 212 in the second direction and the length L5 of the second downstream path 222 in the second direction. In contrast, the length of the nozzle flow path 310 in the second direction may not be longer than the length of the first downstream path 212 in the second direction and the length of the second downstream path 222 in the second direction.

(C-9) In the embodiment described above, the width of the nozzle hole 320 in the third direction is smaller than the width of the first connection port 219 in the third direction and the width of the second connection port 229 in the third direction. In contrast, the width of the nozzle hole 320 in the third direction may be equal to the width of the first connection port 219 in the third direction and the width of the second connection port 229 in the third direction. In this case, the shaping material passing through the first flow path 210 and the shaping material passing through the second flow path 220 can come into close contact with each other in the nozzle flow path 310.

(C-10) In the embodiment described above, the width of the nozzle hole 320 in the third direction is smaller than the width of the first connection port 219 in the third direction and the width of the second connection port 229 in the third direction. In contrast, the width of the nozzle hole 320 in the third direction may be larger than the width of the first connection port 219 in the third direction and the width of the second connection port 229 in the third direction.

(C-11) In the embodiment described above, the width of the upper end portion 311 of the nozzle flow path 310 in the third direction is larger than the width of the nozzle hole 320 in the third direction. In contrast, the width of the upper end portion 311 of the nozzle flow path 310 in the third direction may be equal to or less than the width of the nozzle hole 320 in the third direction.

(C-12) In the embodiment described above, the nozzle flow path 310 has the narrowed portion 313. In contrast, the nozzle flow path 310 may not include the narrowed portion 313.

(C-13) In the above-described embodiment, the narrowed portion 313 has a tapered shape in which the width of the nozzle flow path 310 in the third direction decreases from the upper side toward the lower side. In contrast, the narrowed portion 313 may have a shape in which the width of the nozzle flow path 310 in the third direction decreases from the upper side toward the lower side and may not have a tapered shape.

(C-14) In the embodiment described above, the distance between the heating unit 130 and the flow path forming portion 200 in the second direction is shorter than the distance between the heating unit 130 and the nozzle portion 300 in the second direction. In contrast, the distance between the heating unit 130 and the flow path forming portion 200 in the second direction may not be shorter than the distance between the heating unit 130 and the nozzle portion 300 in the second direction.

(C-15) In the embodiment described above, the width of the first connection port 219 in the third direction is equal to the width of the upper end portion 311 of the nozzle flow path 310. The width of the second connection port 229 in the third direction is equal to the width of the upper end portion 311 of the nozzle flow path 310. In contrast, the width of the first connection port 219 in the third direction may not be equal to the width of the upper end portion 311 of the nozzle flow path 310. The width of the second connection port 229 in the third direction may not be equal to the width of the upper end portion 311 of the nozzle flow path 310.

(C-16) In the embodiment described above, the size of each first connection port 219 and the size of each second connection port 229 are the same. In contrast, the sizes of the first connection ports 219 may be different from each other. The sizes of the second connection ports 229 may be different from each other. The size of the first connection port 219 and the size of the second connection port 229 may be different from each other.

(C-17) In the embodiment described above, the discharge unit 120 may include a pressing portion that presses the shaping material deposited on the shaping surface 410. The pressing portion is, for example, a roller that is attached to an end portion of the discharge unit 120 on the -Z direction side and has an axis along the X direction.

(C-18) In the embodiment described above, the screw 50 has an axial shape centering on a rotation axis AX2. In contrast, the screw 50 may be a flat screw having a substantially cylindrical shape whose height in a direction along the central axis is smaller than its diameter and having a groove forming surface in which spiral grooves are formed.

(C-19) The present disclosure may be realized in the form of the material discharge head 100.

### Other Aspects

The present disclosure is not limited to the embodiments described above, and can be implemented in various aspects without departing from the scope of the present disclosure. For example, the present disclosure can also be implemented in the following aspects. The technical features in the embodiment described above corresponding to the technical features in the aspects described below can be replaced with other technical features or combined with each other as appropriate in order to solve a part or all of the problems of the present disclosure, or to achieve a part or all of the advantages of the present disclosure. Further, the technical features thereof can be deleted as appropriate unless described as essential features in the present specification.

(1) According to a first aspect of the present disclosure, a three-dimensional shaping apparatus is provided. The three-dimensional shaping apparatus includes a material supply unit that supplies a material, a discharge unit that communicates with the material supply unit and discharges the material, and a stage having a shaping surface on which the material discharged from the discharge unit is deposited, the discharge unit including a supply port that communicates with the material supply unit and into which the material is supplied, a flow path forming portion in which a plurality of flow paths, including a first flow path and a second flow path that communicate with the supply port, are formed, and a nozzle portion that communicates with the plurality of flow paths and discharges the material, the first flow path and the second flow path being arranged side by side along the first direction parallel to the shaping surface, and the nozzle portion including a nozzle flow path that communicates with the first and second flow paths and a nozzle hole having a longitudinal direction along the first direction, communicating with the nozzle flow path and discharging the material.

According to such an aspect, the material passing through the first flow path and the material passing through the second flow path come into close contact with each other in the nozzle flow path, thereby making it easier to fill a gap in the first direction between the material passing through the first flow path and the material passing through the second flow path. Therefore, the possibility that a gap is generated in the material discharged from the nozzle hole can be reduced, thereby improving the shaping accuracy.

(2) In the above aspect, the first flow path has a first connection port that is an end portion communicating with the nozzle flow path, the second flow path has a second connection port that is an end portion communicating with the nozzle flow path, and the width of the nozzle hole in the first direction may be larger than the sum of the width of the first connection port in the first direction and the width of the second connection port in the first direction.

According to such an aspect, it is possible to improve the shaping speed while improving the shaping accuracy.

(3) In the above aspect, the first flow path has the first connection port that is an end portion communicating with the nozzle flow path, the second flow path has the second connection port that is an end portion communicating with the nozzle flow path, the first direction includes the first positive direction and the first reverse direction which is a direction opposite to the first positive direction, the second connection port is located on the first positive direction side with respect to the first connection port, and the width of the nozzle hole in the first direction may be larger than the distance in the first direction from an end portion of the first connection port on the first reverse direction side to an end portion of the second connection port on the first positive direction side.

According to such an aspect, a shaped object having a wider width in the first direction can be formed than in a case where the width of the nozzle hole in the first direction is equal to the distance in the first direction from the end portion of the first connection port on the first reverse direction side to the end portion of the second connection port on the first positive direction side.

(4) In the above aspect, the first flow path includes a first upstream path communicating with the supply port and a first downstream path communicating with the first upstream path and the nozzle flow path, the first downstream path includes a first downstream branch path and a second downstream branch path communicating with the first upstream path and the nozzle flow path, the second flow path includes a second upstream path communicating with the supply port and a second downstream path communicating with the second upstream path and the nozzle flow path, the second downstream path includes a third downstream branch path and a fourth downstream branch path communicating with the second upstream path and the nozzle flow path, and the first downstream branch path, the second downstream branch path, the third downstream branch path, and the fourth downstream branch path may be arranged side by side along the first direction.

According to such an aspect, variation in the flow rate of the shaping material passing through the nozzle flow path depending on the position in the first direction can be further suppressed.

(5) In the above aspect, the length of the nozzle flow path in the second direction perpendicular to the shaping surface may be longer than the length of the first downstream path in the second direction and the length of the second downstream path in the second direction.

According to such an aspect, the material passing through the first flow path and the material passing through the second flow path can come into closer contact with each other in the nozzle flow path. Accordingly, the possibility that a gap is generated in the material discharged from the nozzle hole can be further reduced.

(6) In the aspect described above, the first flow path has the first connection port that is an end portion communicating with the nozzle flow path, the second flow path has the second connection port that is an end portion communicating with the nozzle flow path, and the width of the nozzle hole in the third direction parallel to the shaping surface and orthogonal to the first direction may be equal to or less than the width of the first connection port in the third direction and the width of the second connection port in the third direction.

According to such an aspect, the material passing through the first flow path and the material passing through the second flow path can come into closer contact with each other in the nozzle flow path. Accordingly, the possibility that a gap is generated in the material discharged from the nozzle hole can be further reduced.

(7) In the above aspect, the width of the nozzle hole in the third direction parallel to the shaping surface and orthogonal to the first direction may be smaller than the width of an upper end portion of the nozzle flow path in the third direction.

According to such an aspect, the material passing through the first flow path and the material passing through the second flow path can come into closer contact with each other in the nozzle flow path. Accordingly, the possibility that a gap is generated in the material discharged from the nozzle hole can be further reduced.

(8) In the above aspect, the nozzle flow path may have a narrowed portion in which the width of the nozzle flow path in the third direction decreases from an upper side to a lower side.

According to such an aspect, the material passing through the first flow path and the material passing through the second flow path can come into closer contact with each other in the narrowed portion. Accordingly, the possibility that a gap is generated in the material discharged from the nozzle hole can be further reduced.

(9) In the above aspect, the shaping apparatus may further include a heating unit that heats the discharge unit, and the distance between the heating unit and the flow path forming portion in the second direction perpendicular to the shaping surface may be shorter than the distance between the heating unit and the nozzle portion in the second direction.

According to such an aspect, the shaping material inside the nozzle portion is readily cooled, making it easier to discharge the shaping material from the nozzle hole at a temperature suitable for shaping.

(10) According to the second aspect of the present disclosure, a material discharge head that discharges a material onto a stage is provided. The material discharge head includes a discharge unit that discharges the material, the discharge unit including a supply port into which the material is supplied, a flow path forming portion in which a plurality of flow paths, including a first flow path and a second flow path that communicate with the supply port, are formed, and a nozzle portion that communicates with the plurality of flow paths and discharges the material, the first flow path and the second flow path being arranged side by side along the first direction parallel to the surface of the stage, and the nozzle portion including a nozzle flow path that communicates with the first and second flow paths and a nozzle hole having a longitudinal direction along the first direction, communicating with the nozzle flow path and discharging the material.

According to such an aspect, the material passing through the first flow path and the material passing through the second flow path come into close contact with each other in the nozzle flow path, thereby making it easier to fill a gap in the first direction between the material passing through the first flow path and the material passing through the second flow path. Therefore, the possibility that a gap is generated in the material discharged from the nozzle hole can be reduced, thereby improving the shaping accuracy.

What is claimed is:

1. A three-dimensional shaping apparatus comprising:
a material supply unit that supplies a material, a discharge unit that communicates with the material supply unit and discharges the material, and a stage having a shaping surface on which the material discharged from the discharge unit is deposited;
wherein the discharge unit includes a supply port that communicates with the material supply unit and into which the material is supplied, a flow path forming portion in which a plurality of flow paths, including a first flow path and a second flow path that communicate with the supply port, are formed, and a nozzle portion that communicates with the plurality of flow paths and discharges the material, the first flow path and the second flow path being arranged side by side along the first direction parallel to the shaping surface; and
the nozzle portion including a nozzle flow path that communicates with the first and second flow paths and a nozzle hole having a longitudinal direction along the first direction, communicating with the nozzle flow path and discharging the material.

2. The three-dimensional shaping apparatus according to claim 1,
wherein the first flow path has a first connection port that is an end portion communicating with the nozzle flow path,
the second flow path has a second connection port that is an end portion communicating with the nozzle flow path, and
the width of the nozzle hole in the first direction is larger than the sum of the width of the first connection port in the first direction and the width of the second connection port in the first direction.

3. The three-dimensional shaping apparatus according to claim 1,
wherein the first flow path has the first connection port that is an end portion communicating with the nozzle flow path,
the second flow path has the second connection port that is an end portion communicating with the nozzle flow path,
the first direction includes the first positive direction and the first reverse direction which is a direction opposite to the first positive direction,
the second connection port is located on the first positive direction side with respect to the first connection port, and
the width of the nozzle hole in the first direction is larger than the distance in the first direction from an end portion of the first connection port on the first reverse direction side to an end portion of the second connection port on the first positive direction side.

4. The three-dimensional shaping apparatus according to claim 1,
wherein the first flow path includes a first upstream path communicating with the supply port and a first downstream path communicating with the first upstream path and the nozzle flow path,
the first downstream path includes a first downstream branch path and a second downstream branch path communicating with the first upstream path and the nozzle flow path,
the second flow path includes a second upstream path communicating with the supply port and a second downstream path communicating with the second upstream path and the nozzle flow path,
the second downstream path includes a third downstream branch path and a fourth downstream branch path communicating with the second upstream path and the nozzle flow path, and
the first downstream branch path, the second downstream branch path, the third downstream branch path, and the fourth downstream branch path are arranged side by side along the first direction.

5. The three-dimensional shaping apparatus according to claim 4, wherein the length of the nozzle flow path in the second direction perpendicular to the shaping surface is longer than the length of the first downstream path in the second direction and the length of the second downstream path in the second direction.

6. The three-dimensional shaping apparatus according to claim 1,
wherein the first flow path has the first connection port that is an end portion communicating with the nozzle flow path,
the second flow path has the second connection port that is an end portion communicating with the nozzle flow path, and
the width of the nozzle hole in the third direction parallel to the shaping surface and orthogonal to the first direction is equal to or less than the width of the first connection port in the third direction and the width of the second connection port in the third direction.

7. The three-dimensional shaping apparatus according to claim 1, wherein the width of the nozzle hole in the third direction parallel to the shaping surface and orthogonal to the first direction is smaller than the width of an upper end portion of the nozzle flow path in the third direction.

8. The three-dimensional shaping apparatus according to claim 7, wherein the nozzle flow path has a narrowed portion in which the width of the nozzle flow path in the third direction decreases from an upper side to a lower side.

9. The three-dimensional shaping apparatus according to claim 1, further comprising a heating unit that heats the discharge unit, and the distance between the heating unit and the flow path forming portion in the second direction perpendicular to the shaping surface is shorter than the distance between the heating unit and the nozzle portion in the second direction.

10. A material discharge head that discharges a material onto a stage, comprising a discharge unit that discharges the material, the discharge unit comprising:
a supply port into which the material is supplied,
a flow path forming portion in which a plurality of flow paths, including a first flow path and a second flow path communicating with the supply port, are formed; and
a nozzle portion that communicates with the plurality of flow paths and discharges the material,
the first flow path and the second flow path being arranged side by side along the first direction parallel to the surface of the stage, and
the nozzle portion including a nozzle flow path communicating with the first and second flow paths, and a nozzle hole having a longitudinal direction along the first
direction, communicating with the nozzle flow path and discharging the material.
